(19) United States
(12) Patent Application Publication
(10) Pub. No.: US 2026/0004034 A1
(43) Pub. Date: Jan. 1, 2026

(54) Event-Based Power Analysis with Integrated Timing Characterization and Logic Simulation

(71) Applicants: Katayoon BASHARKHAH, Leuven (BE); Zainalabedin NAVABI, Walpole, MA (US)

(72) Inventors: Katayoon BASHARKHAH, Leuven (BE); Zainalabedin NAVABI, Walpole, MA (US)

(21) Appl. No.: 19/254,661

(22) Filed: Jun. 30, 2025

Related U.S. Application Data
(60) Provisional application No. 63/666,558, filed on Jul. 1, 2024.

(51) Int. Cl. G06F 30/3308; G06F 119/06

(52) U.S. Cl. CPC G06F 30/3308; G06F 2119/06

(57) ABSTRACT

A method for providing power analysis of a circuit comprises estimating output power during a time interval for a gate of the circuit based on an input event; and including the estimated output power of the gate in the power analysis of the circuit. In some implementations, estimating output power includes considering, for the gate, an “output timing reject region” of the input event in which a pulse width at the input is between two thresholds, the thresholds being selected such that the input event does not propagate to an output of the gate. Nevertheless, the input event contributes partially to the estimated output of the gate. In some implementations, estimating output power includes implementing a live gate model using gate datasheet information stored by the gate.

### CROSS-REFERENCE TO RELATED APPLICATIONS

This application claims priority to U.S. Provisional Patent Application No. 63/666,558, filed Jul. 1, 2024, entitled “Event-Based Power Analysis with Integrated Timing Characterization and Logic Simulation,” which is herein incorporated by reference in its entirety.

### TECHNICAL FIELD

The present disclosure relates generally to event-based power analysis, and particularly to event-based power analysis with integrated timing characterization and logic simulation.

### BACKGROUND

Some important features of digital systems include their power consumption and battery life. These features need to be considered in designing improved digital parts. In this regard, simulation tools have generally been focusing on functionality and timing analysis, while requirements for portability, battery life, security, and reliability make expectations from digital system design analysis tools to go far beyond just functional and timing simulations. Among other analysis programs, power simulation stands out as an important tool in design process after functional and timing simulation. However, unlike timing simulation that is a well-thought-of part in Electronic Design Automation (EDA) tools, power simulation tools are like an orphaned child of EDA and have often lagged behind timing simulation. Improvements of these and other tools are required for designing enhanced electronic devices.

### SUMMARY

Some implementations relate to a method for providing power analysis of a circuit, the method including: estimating output power during a time interval for a gate of the circuit based on an input event, wherein: estimating the output power includes considering, for the gate, an output timing reject region of the input event, the output timing reject region has a pulse width between a first threshold and a second threshold, the first threshold and the second threshold are selected such that the input event does not propagate to an output of the gate, and the input event contributes to the estimated output power for the gate; and including the estimated output power of the gate in the power analysis of the circuit.

Some implementations relate to a method, wherein estimating the output power further includes implementing a live gate model that uses gate datasheet information stored by the gate.

Some implementations relate to a method, wherein the gate datasheet information includes a parameter corresponding to the gate, the parameter including at least one of delay, transition time, or output capacitance.

Some implementations relate to a method, wherein the parameter is calculated by the live gate model for the gate dynamically while simulating the input event.

Some implementations relate to a method, wherein the gate datasheet information is specific to a data structure of the gate.

Some implementations relate to a method, wherein the live gate model is a SystemC model.

Some implementations relate to a method, wherein a sprocket signal causes the live gate model to estimate its output power corresponding to the gate.

Some implementations relate to a method, wherein: the gate is a first gate, the circuit includes a plurality of gates including the first gate and a second gate, the input event is a first input event included in a plurality of input events respectively occurring on the plurality of gates for the time interval, and the method further includes: estimating output power during the time interval for the second gate based on a second input event of the plurality of input events, wherein: estimating the output power includes considering, for the second gate, an output power reject region of the second input event, the output power reject region has a pulse width below the first threshold, the first threshold is defined such that the second input event does not propagate to an output of the second gate, and the second input event either does not contribute to the output power or a ratio of the second input event contributes to the output power; and estimating a total power for the time interval by including the estimated output power of the second gate in the power analysis of the circuit.

Some implementations relate to a method, wherein the first gate is cascaded with the second gate.

Some implementations relate to a method, wherein the second input event is a glitch defined by the pulse width of the second input event being below the first threshold.

Some implementations relate to a method, wherein; the plurality of gates includes a third gate, and the method further includes: estimating output power during the time interval for the third gate based on a third input event of the plurality of input events, wherein: estimating the output power includes considering, for the third gate, an output timing inertial region of the third input event, the output timing inertial region has a pulse width above the second threshold, the second threshold is defined such that the third input event propagates to an output of the third gate, and the third input event fully contributes to the output power; and estimating a total power for the time interval by including the estimated output power of the third gate in the power analysis of the circuit.

Some implementations relate to a method, wherein: the gate is a first gate, the circuit includes a plurality of gates including the first gate and a second gate, the input event is a first input event included in a plurality of input events respectively occurring on the plurality of gates for the time interval, and the method further includes: estimating output power during the time interval for the second gate based on a second input event of the plurality of input events, wherein: estimating the output power includes considering, for the second gate, an output timing inertial region in which the pulse width of the second input event is above the second threshold, the second threshold is defined such that the second input event propagates to an output of the second gate, and the second input event fully contributes to the output power; and estimating a total power for the time interval by including the estimated output power of the second gate in the power analysis of the circuit.

Some implementations relate to a method, wherein: the event is a simulated switching activity on the gate, and the output power is estimated as the switching activity occurs.

Some implementations relate to a method, wherein: the circuit includes a plurality of gates including the gate, the input event is included in a plurality of input events occurring on the plurality of gates, and the output power is estimated for the plurality of gates based on the plurality of input events.

Some implementations relate to a method, wherein at least one first gate, of the plurality of gates, is cascaded with at least one second gate of the plurality of gates.

Some implementations relate to a method, wherein the power analysis includes integrated timing characterization and logic simulation.

Some implementations relate to a method, wherein the time interval is a clock cycle.

Some implementations relate to a method, wherein the time interval is a fraction of a clock cycle.

Some implementations relate to a method for providing power analysis of a circuit, the method including: estimating output power during a time interval for a gate of the circuit based on an input event, wherein: estimating the output power includes implementing a live gate model using gate datasheet information stored by the gate, the gate datasheet information is specific to a data structure of the gate, the gate datasheet information includes at least one parameter, and the at least one parameter includes at least one of delay, transition time, or output capacitance; and including the estimated output power of the gate in the power analysis of the circuit.

Some implementations relate to a method, wherein the live gate model calculates the at least one parameter based on aging of the gate.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the implementations described herein. The accompanying drawings, which are incorporated in this specification and constitute a part of it, illustrate several implementations consistent with the disclosure. Together with the description, the drawings serve to explain the principles of the disclosure.

In the drawings:

FIG. 1 is a block diagram of a device 100 on which some implementations of the disclosed technology can operate.

FIG. 2 is a block diagram illustrating an overview of an environment 200 in which some implementations of the disclosed technology can operate.

FIG. 3 is a block diagram illustrating components 300 which, in some implementations, can be used in a system employing the disclosed technology.

FIG. 4A illustrates a circuit 400A of cascaded gates U1-U5 according to some implementations

FIG. 4B illustrates an output pulse diagram 400B according to some implementations.

FIG. 5 is a flow chart corresponding to a method 500 performed by one or more specialized components, according to some implementations.

FIG. 6 is a flow chart corresponding to a method 600 performed by one or more specialized components, according to some implementations.

FIG. 7 illustrates a circuit 700 including an AND gate G1, for which power analysis can be performed according to some implementations such as method 600 of FIG. 6.

FIG. 8A illustrates a cell library of cell structures according to summons implementations.

FIG. 8B shows an abstract view of a two-input AND SC_MODULE, according to some implementations.

FIG. 9 shows an overall flow of a system architecture, according to some implementations.

FIG. 10 is a graph 1000 depicting the execution time of different benchmark circuits, according to some implementations.

FIG. 11 is a graph 1100 showing the power traces of an S-box submodule of an AES circuit simulated and estimated, according to some implementations.

### DETAILED DESCRIPTION

The following detailed description refers to the accompanying drawings. The same or similar reference numbers can have been used in the drawings or in the description to refer to the same or similar parts. Also, similarly named elements can perform similar functions and can be similarly designed, unless specified otherwise. Details are set forth to provide an understanding of the exemplary implementations. Implementations, e.g., alternative implementations, can be practiced without some of these details. In other instances, well known techniques, procedures, and components have not been described in detail to avoid obscuring the described implementations.

With the shrinking size of transistors in the most advanced technologies and demand for battery-operated devices, dynamic power estimation has become a major concern. State of the art power estimation environments strongly depend on gate-level static timing characterization and dynamic logic simulation that are external to power estimation tools. This imposes a large overhead on power analysis speed and makes timing and power analysis two separate passes. This separation prevents utilization of dynamic timing information that would be useful for power analysis.

Thus, there is a need for tools that are fast, accurate, easy-to-use, and integrated with other design tools. Applications such as Dynamic Voltage and Frequency Scaling (DVFS), power tracing for security, power prediction for Dynamic State Evaluation (DSE), and power-aware compiler development can benefit from a fast integrated environment for power analysis.

An important part of a power analysis tool may be the power characterization that is extracted from the layout or transistor level netlist and propagated to the upper design abstraction levels. Power characterization can require physical properties that generally exist in SPICE models of transistors and interconnects. Information extracted from SPICE models may be included in gate-level technology file information that are used in commercial power estimation tools. Still, these tools come at the cost of long logic simulation time, because running different testbenches on designs with millions of gates can take a long run time. Since timing simulation can be a requirement for the power simulation, coupling these two in an event-driven simulator can result in a significant increase in the power simulation accuracy and performance.

However, the existing power tools are decoupled from the timing simulation. Instead of simultaneous evaluation of timing and power with a given input dataset, existing tools can use two separate passes. In the first simulation pass, logical and timing simulations are performed on a netlist of gates, and circuit node waveforms are produced and captured in waveform formats such as a VCD file. Without being able to manipulate the input data, the second pass can use the VCD file in a non-interactive batch fashion and performs power simulation for the entire timing simulation run.

This two-pass simulation process presents several problems. First, two complete simulations with the same order of complexity may have to be performed. There are n gates in the first pass, and there are n nodes in the second pass. Secondly, the two passes may require separate setups and file exchange between the two. A still bigger issue with this two-pass simulation is the non-interactive batch nature of the power simulation pass. Another problem with this is the fact that some information that may not be significant in timing waveforms and can affect power and energy are missed from the VCD files. Take, for example, short glitches below the gate inertial delay values that are dropped from the VCD files. For the above reasons, delay aware and glitch-enabled power simulation is an important part of an accurate power estimation in the design flow.

To address the above issues and, at the same time, to move away from complex commercial software programs, some implementations described herein incorporate computations in gate models, and perform timing and power calculations in one place in SystemC gate models. After the post-layout netlist is generated, it is converted to a gate netlist in SystemC. The corresponding technology and post-layout details can be ported into SystemC gate models that are simulated in the SystemC event-driven simulation environment.

Some implementations relate to a distributed simulation environment in which, instead of a large simulation software program and a large data structure, calculations are performed in each gate using the data structure of that particular gate. In such implementations, simulations can be faster, can be performed in one pass, and future changes to the simulation can only require gate-level programming rather than software programming expertise to deal with complex simulators. In this simulation environment, timing simulation can be generated in the gate models, and consumed inside the gate models for logical, delay, and power calculations. The one-pass coupled simulation makes this an adaptive simulation. According to some implementations described herein, accuracy of combined timing and power calculations can closely match those of the two passes of timing simulation and power analysis tools, while the SystemC simulation runtime can outperform just the timing simulation pass by a factor of at least 2×.

Power estimation at different levels of abstraction can be based on using the power information of the circuit sub-components at that specific level. This information can be back-annotated from the physical low level for each component in terms of macromodels. These macromodels in their simplest form are look-up tables (abbreviated to LUT) extracted based on lower-level information and indexed by abstract specific parameters.

Gate macromodels may use the switching activity of the gates as the main parameter for dynamic power consumption. The internal energy dissipation for each rise or fall transition are usually pre-characterized in the standard library cell of the target technology. The library description of each cell includes two-dimensional tables as functions of the input transition on the gate input and the load capacitance at the gate output. This can be a template for three determinative power factors, i.e., output transition time, delay, and energy per transition. Power estimation tools look-up the energy per transitions for each input signal state while finding the transition rates from either logic simulation or the probabilistic approaches for a specific time interval. This time interval in most power estimation tools can be selected to include multiple clock cycles to simplify estimations to an average power calculation.

The switching information extracted from the logic simulation requires to be time accurate including exact delays on the gate outputs and the effect of glitches of the gate inputs. This would be done in a separate timing characterization step. Most reputed power estimation tools are based on the SDF-based logic simulators, in which delay values are back-annotated to Standard Delay Format (SDF) files using an STA tool.

Some implementations of the power analysis tool described herein take the switching activities in form of Value Changed Dump (VCD). In addition, the capacitance of the gate outputs can be an important factor for delay and power estimation in some implementations. The parasitic information can be estimated based on pre-layout design or in a more accurate way based on post-layout Standard Parasitic Exchange Format (SPEF) files.

Conventional power analysis tools may have a strong dependency on several external and separate tools. For example, VCD files are usually generated in timing simulation tools and SDF files are extracted from power analysis tool or synthesis tool. The parasitic capacitances generated based on pre-layout or post-layout approach are generated from synthesis or layout tools. This puts power analysis at the mercy of the synthesis tool. Transporting data in between these tools imposes large timing overheads as well as disk usage for the conventional power estimation method. To remove this dependency in power estimation flow, an integrated environment can be required to eliminate the file exchange and provide synchronization between timing and simulation tools.

Thus, given the topology of the circuit, the target library cell and input test vectors, the power estimation tool described herein may, in some implementations, simulate the switching activities of all gates with exact delay and glitches and estimate the power of each gate and the total design dynamically per clock cycle (or other time interval, such as a fraction of a clock cycle or multiple clock cycles). Thus, some implementations relate to an integrated timing and power environment leveraging tool independency for a much faster analysis time. The environment can perform several tasks in parallel, consuming events as they occur, thereby leading to cost-effective power estimation.

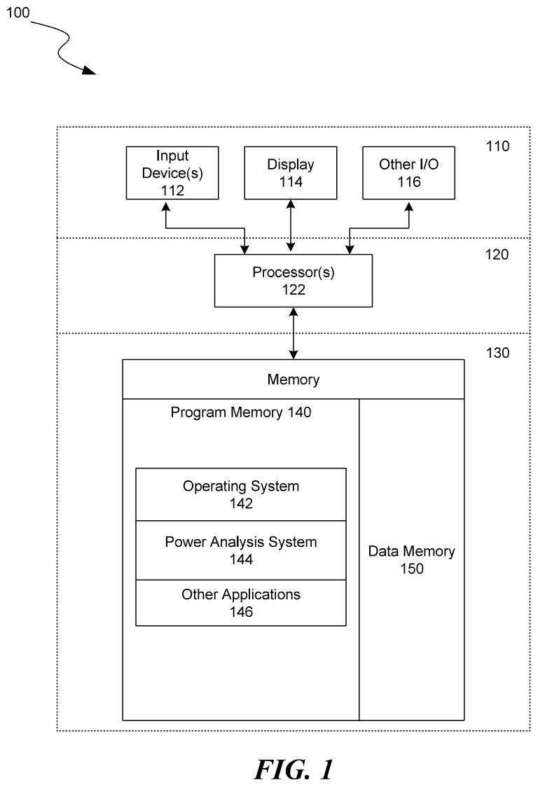

Several implementations are discussed below in more detail in reference to the figures. FIG. 1 is a block diagram of a device 100 on which some implementations of the disclosed technology can operate. The devices can comprise hardware components that can provide power analysis of a circuit. Device 100 can include an input/output section 110, a processor section 120, and a memory section 130. Processor section 120 can include one or more processors 122. Memory section 130 can include a program memory 140 and a data memory 150.

Input/output section 110 can include one or more input devices 112, one or more displays 114, or other input/output devices 116. Input/output section 110 can include devices such as, for example, a mouse, a keyboard, a touchscreen, an infrared sensor, a touchpad, a wearable input device, a camera- or image-based input device, a microphone, or other user input devices.

Input/output section 110 can provide input to processor section 120, including one or more processor(s) 122 (e.g., CPU(s), GPU(s), HPU(s), etc.), notifying it of actions relative to input section 110. Processor(s) 122 can be a single processing unit or multiple processing units in a device or distributed across multiple devices. Processor(s) 122 can be coupled to other hardware devices, for example, with the use of a bus, such as a PCI bus or SCSI bus. Processor(s) 122 can communicate with a hardware controller for devices, such as for display 114. Display 114 can be used to display text and graphics. In some implementations, display 114 provides graphical and textual visual feedback to a user. In some implementations, display 114 includes the input device as part of the display, such as when the input device is a touchscreen or is equipped with an eye direction monitoring system. In some implementations, the display can be separate from the input device. Examples of display devices are: an LCD display screen, an LED display screen, a projected, holographic, or augmented reality display (such as a heads-up display device or a head-mounted device), and so on. Other I/O devices 116 can also be coupled to processor section 120; I/O devices 116 can include a network card, video card, audio card, USB, firewire or other external device, camera, printer, speakers, CD-ROM drive, DVD drive, disk drive, or Blu-Ray device.

In some implementations, device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

Processor section 120 can have access to memory section 130 in a device or distributed across multiple devices. As used herein, a “memory” includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. In some implementations, the memory is not a propagating signal divorced from underlying hardware, and therefore, is non-transitory. Memory section 130 can include program memory 140 that stores programs and software, such as an operating system 142, power analysis system 144, and other application programs 146. Memory section 130 can also include data memory 150 for storing, e.g., output power estimation data, input event data, switching activity data, output pulse width data, threshold data, propagation data, gate datasheets and lookup tables, algorithm data, modeling data, configuration data, settings, user options or preferences, etc. Such data can be provided to program memory 140 or any element of device 100.

Some implementations can be operational with numerous other computing system environments or configurations. Examples of computing systems, environments, or configurations that can be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

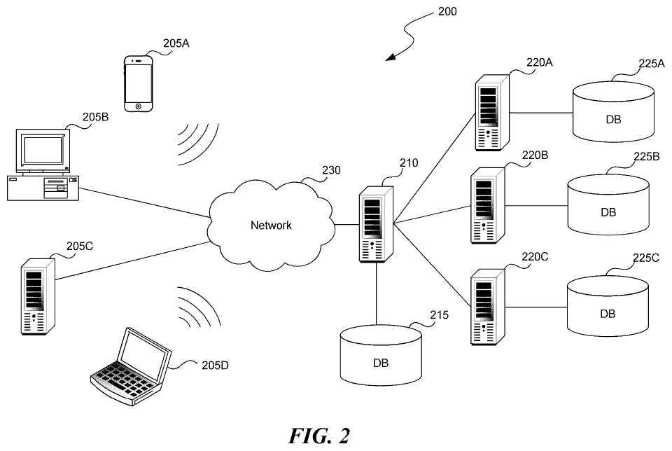

FIG. 2 is a block diagram illustrating an overview of an environment 200 in which some implementations of the disclosed technology can operate. Environment 200 can include one or more client computing devices 205A-D, at least one server computing device 210 connected to a server database storage 215, one or more computing devices 220 connected to one or more local database storages 225, and a network 230.

Examples of client computing devices 205 can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as output power estimation data, input event data, switching activity data, output pulse width data, threshold data, propagation data, gate datasheets and lookup tables, algorithm data, modeling data, etc. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 can be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

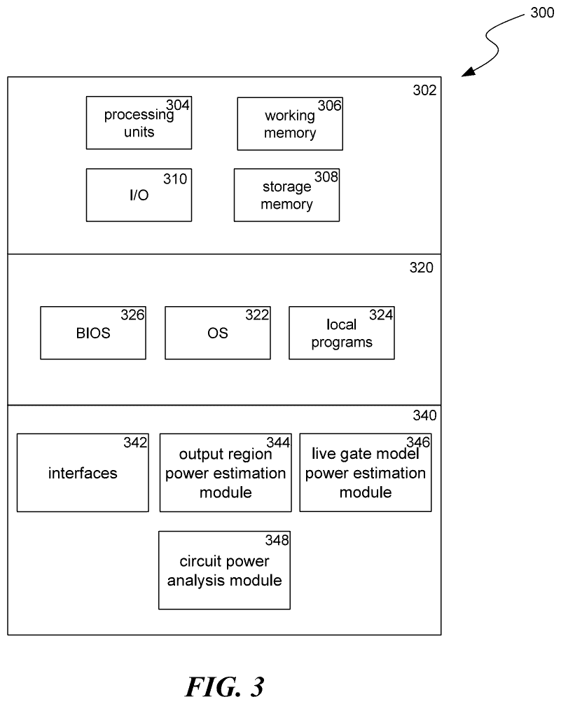

FIG. 3 is a block diagram illustrating components 300, which, in some implementations, can be used in a system employing the disclosed technology. The components 300 include hardware 302, general software 320, and specialized components 340. Components 300 can be implemented in a client computing device such as client computing devices 205 or on a server computing device, such as server computing device 210 or 220.

As discussed above, a system implementing the disclosed technology can use various types of hardware 302 including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220).

General software 320 can include various applications including an operating system 322, local programs 324, and a basic input output system (BIOS) 326.

In some implementations, components 300 can be in a computing system that is distributed across multiple computing devices or can be an interface to a server-based application executing one or more of specialized components 340.

In various implementations, specialized components 340 can include one or more specialized hardware, or logical or other nonphysical differentiations of functions or can be submodules or code-blocks of one or more applications.

Specialized components 340 can be subcomponents of a general software application 320, such as local programs 324. Specialized components 340 can include components that can be used for providing user interfaces such as interfaces 342, transferring data, and controlling one or more of the other specialized components. Specialized components 340 can further include an output region power estimation module 344, a live gate model power estimation module 346, and a circuit power analysis module 348. For example, for a circuit consisting of N gates, power estimation module 344 can calculate the output region of an independent gate, power estimation module 346 can calculate the gate power considering gate interconnection to the other gates, and circuit power analysis module 348 can calculate the power of the entire circuit considering the power of each gate, as described further herein.

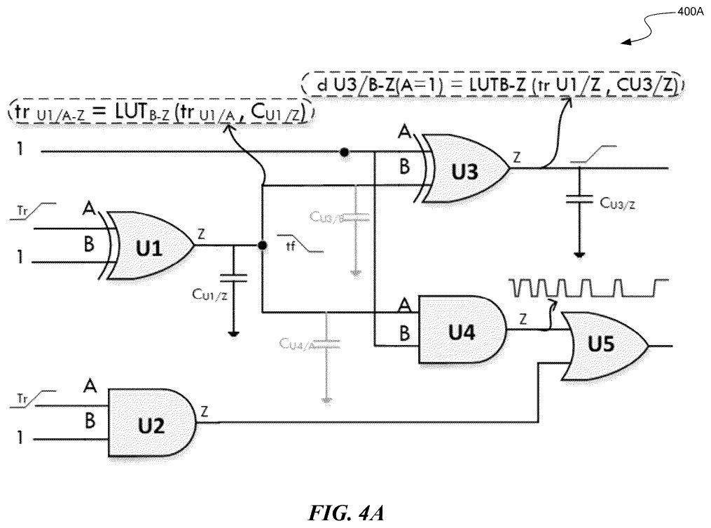

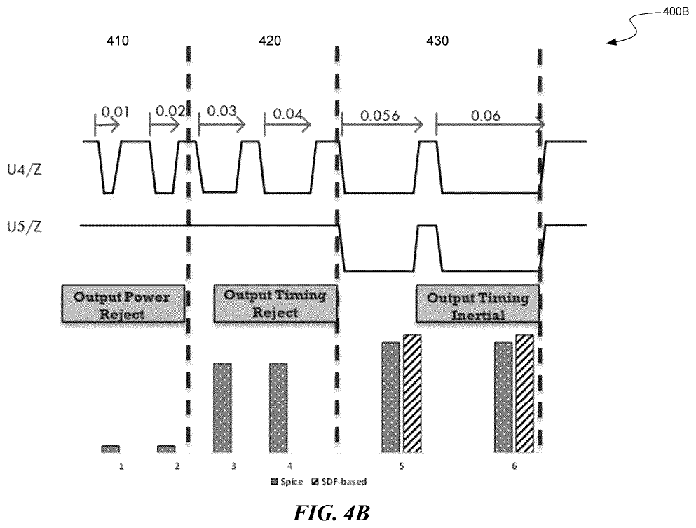

Output region power estimation module 344 can estimate output power during a time interval for a logic gate (e.g., AND, OR, XOR, NAND, NOR, XNOR, or NOT) of a circuit based on an input event by considering one or more regions classifying the input event. The input event can include, for example, one or more simulated switching events occurring on the input of the gate. In some implementations, the gate can be cascaded with another gate, i.e., the gate can receive one or more inputs that are one or more outputs of one or more other gates in the circuit; or one or more outputs of the gate can be one or more inputs of one or more other gates in the circuit. Output region power estimation module 344 can calculate the output power of the gate based on one or more of three output pulse regions, discussed in further detail below, in relation to FIGS. 3, 4A, and 4B.

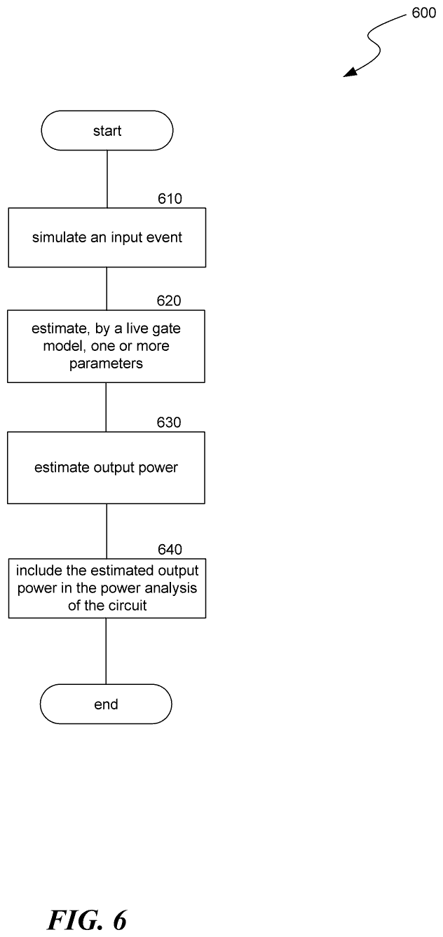

Live gate model power estimation module 346 can estimate output power during a time interval for a logic gate (e.g., AND, OR, XOR, NAND, NOR, XNOR, or NOT) of a circuit based on an input event by implementing a live gate model using gate datasheet information stored by the gate. The input event can include, for example, one or more simulated switching events occurring on the input of the gate. In some implementations, the gate can be cascaded with another gate. The live gate model can be, for example, a System C model or can be implemented using a C++ programming language. The gate datasheet information can be specific to a data structure of the gate, and can include at least one parameter of the gate, such as delay, transition time, output capacitance (including, e.g., wire capacitance and load capacitance), aging of the gate, etc. Further details regarding estimating output power during a time interval for a gate of a circuit by implementing a live gate model are described herein with respect to FIG. 6.

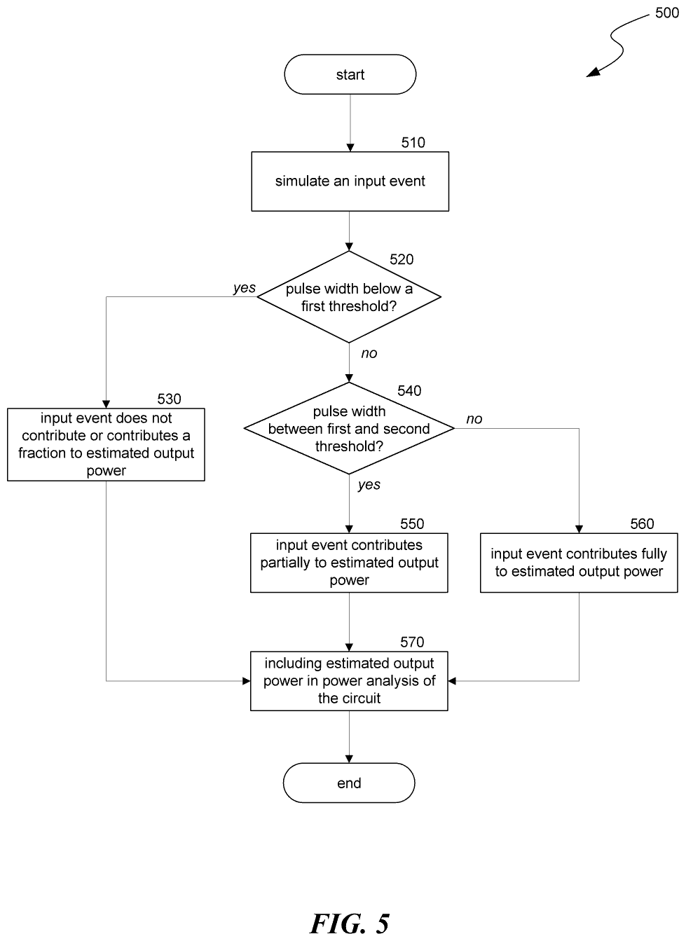

Circuit power analysis module 348 can include, in the power analysis of the circuit, the output powers estimated by output power estimation module 344 and by live gate model power estimation module 346. In some implementations, however, it is contemplated that circuit power analysis module 348 can include only one of the output powers estimated by output power estimation module 344 or by live gate model power estimation module 346. For example, circuit power analysis module 348 can aggregate the estimated output power for a plurality of gates in the circuit to estimate the total output power of the circuit. In some implementations, circuit power analysis module 348 can apply the estimated output power at one gate to a next cascaded gate to determine the estimated output power of the next gate, and so on and so forth, such as to estimate output power at the terminal gates of the circuit. Further details regarding including estimated output power of one or more gates in power analysis of a circuit are described herein with respect to FIGS. 5 and 6.

When performing logic simulation of a gate-level circuit, considering the gate delay can be necessary but not sufficient for power estimation. An inherent constraint of logic simulation can be that the input transitions that would cause glitches on the output would be absorbed within a gate and can not necessarily be propagated to the input of the next gate. However, the partial-swing transition on the absorbed event can consume power despite timing propagation filtering. Power estimation tools usually work based on SDF-annotated delays that use inertial delay filtering and too many of the valid pulses will be rejected. On the other hand, considering all the events on the input pins can lead to an overestimation of the power.

To solve this problem, some implementations described herein can consider three different regions for propagation of input events that would cause output pulses. To demonstrate the problem, FIG. 4A shows a circuit 400A for which the output pulses are demonstrated in output pulse diagram 400B of FIG. 4B. More specifically, FIG. 4A illustrates a circuit 400A of cascaded gates U1-U5, as further described next. Further, output pulse diagram 400B includes an increasing width negative pulse for U4/Z of circuit 400A.

Regarding FIG. 4A, circuit 400A includes an XOR (exclusive OR) gate U1 with two inputs: the first input is A, a changed input (e.g., pulsed), and the second input is B, a high input (1). The output, Z, of XOR gate U1 can be therefore a changed output that is only high if either A or B is high, but not both. XOR gate U1 has an output capacitance CUI/Z.

Circuit 400A further includes an AND gate U2 with two inputs: the first input is A, a changed input (such as from a clock oscillator), and the second input is B, a high input (1). The output, Z, of AND gate U2 can be therefore a pulsed output that is high only if both A and B are high.

Circuit 400A further includes an XOR (exclusive OR) gate U3 with two inputs: A, a high input (1), and B, which is connected to the changed output, Z, of XOR gate U1. XOR gate U3 has an input capacitance of CU3/B. The output, Z, of XOR gate U3 is a changed output, that is, Z is high only if either A or B is high, but not both. XOR gate U3 has an output capacitance of CU3/Z.

Circuit 400A further includes an AND gate U4 with two inputs: the first input is A, which is connected to the changed output, Z, of XOR gate U1, and the second input is B, a high input (1). AND gate U4 has an input capacitance of CU4/A. The output, Z, of AND gate U4 can be a changed output, that is, Z is a high only high if both A and B are high.

Circuit 400A further includes an OR gate U5 with two inputs: the first input is A, which is connected to the pulsed output, Z, of AND gate U4, and the second input is B, which is connected to the changed output, Z, of AND gate U2. The output, Z, of OR gate U5 can be therefore a changed output that is only high if at least one of A and B is high.

Regarding FIG. 4B, the output pulses shown in output pulse diagram 400B is divided into three regions 410, 420, and 430, described next. For this discussion, FIG. 4B illustrates the output pulses and corresponding output power contribution regions for gates U4 and U5 of circuit 400A of FIG. 4A according to some implementations described herein (“Spice”) as compared to conventional power analysis techniques (“SDF-based”). Specifically, the outputs of AND gate U4 (“U4/Z”) and OR gate U5 (“U5/Z”) are shown for these regions: an output power reject region, an output timing reject region, and an output timing inertial region.

These regions are defined based on the input pulse width. Pulse width in power reject region, output timing reject region, and output timing inertial region are from smallest to largest respectively. Two pulse width thresholds define the lines between these three regions. The first threshold is between region 410 and 420. The second threshold is between regions 420 and 430. The pulse width in the first region, that is, region 410, can be too small to make a contribution in the output power. Hence, this region has been termed the output power reject region 410. In the output power reject region 410, a small fraction of the power can be affected, but no logic value will be propagated to the next gate.

In the output power reject region 410, the input event on an input of the gate (which can be cascaded with another gate in some implementations) can have a pulse width below a first threshold (e.g., a glitch). Thus, the input event does not propagate to the output of the gate. Output power estimation module 344 of FIG. 3 described herein can disregard the input event in calculating the output power of the gate or can consider a fraction of the input event in calculating the output power of the gate during the time interval.

In the output timing reject region 420, the input event on an input of the gate can have a pulse width between the first threshold and a second threshold. In the output timing reject region 420, the input event also does not propagate to the output of the gate. Output power estimation module 344 of FIG. 3 can nevertheless, however, partially consider the input event in calculating the output power of the gate during the time interval. Determination of the partial amount is based on a SPICE simulation, which is the golden reference for electronic circuit timing and power estimation. For example, for the output power reject region 410 or the output timing reject region 420, the fraction or partial consideration of the input event can be estimated by running transistor-level simulations and observing the power traces. SPICE can run several simulations for each gate with different tests, both toggling and non-toggling, and observe the power at each transistor stage. In some implementations, the partial consideration of the input event for the output timing reject region 420 can be higher than the ratio of the input event considered in the output power reject region 410.

In the output timing inertial region 430, the input event on an input of the gate can have a pulse width above the second threshold. In the output timing inertial region 430, the input event propagates to the output of the gate. Output power estimation module 344 of FIG. 3 can fully consider the input event in calculating the output power of the gate during this time interval. Further details regarding estimating output power for a gate based on an output power reject region 410, an output timing reject region 420, or an output timing inertial region 430 are described herein with respect to FIG. 5.

Elaborating on the above with specific timing examples, in the output power reject region 410, output pulse U4/Z has a negative pulse width below a first threshold, e.g., 0.03 μs. Specifically, the first negative pulse is 0.01 μs in duration, and the second negative pulse is 0.02 μs in duration. In the output power reject region 410, the output of AND gate U4, U4/Z, does not propagate to the output of OR gate U5, U5/Z. Nevertheless, according to some implementations described herein, a fraction of the input power to OR gate U5 (represented by the output power of AND gate U4, U4/Z) is considered in estimating the output power of circuit 400A (e.g., at OR gate U5), as shown in FIG. 4A.

Regarding the second region, that is, region 420, although this region includes pulses with wider width that have a partial contribution in the output power, the output swing can still not be observable at the output of the gate, because it is not large enough to cause switching of gate transistors. This region is called the output timing reject region 420, in which the events should be counted for power estimation but still not propagated as the output logic values.

In a specific example, in the output timing reject region 420, output pulse U4/Z has a negative pulse width at or above the first threshold (e.g., 0.03 μs) and below a second threshold (e.g., 0.056 μs). Specifically, the third negative pulse is 0.03 μs in duration, and the fourth negative pulse is 0.04 μs in duration. In the output timing reject region 420, the output of AND gate U4, U4/Z, does not propagate to the output of OR gate U5, U5/Z. Nevertheless, according to some implementations described herein, the input power to OR gate U5 (corresponding to the output power of AND gate U4, U4/Z), can be partially considered in estimating the output power of circuit 400A (e.g., at OR gate U5), as shown in FIG. 4A.

The last region, that is, region 430, is called the output timing inertial region where all the events are observable and have a full contribution in the output power estimation. Conventional SDF-based tools take counts of the output toggle only in the output timing inertial region 430 and only partially consider the output timing reject region 420.

In a specific example, in the output timing inertial region 430, output pulse U4/Z has a pulse width at or above the second threshold (e.g., 0.056 μs). Specifically, the fifth negative pulse is 0.056 μs in duration, and the sixth negative pulse is 0.06 μs in duration. In the output timing inertial region 430, the output of AND gate U4, U4/Z, propagates to the output of OR gate U5, U5/Z. According to some implementations described herein, the input power to OR gate U5 (corresponding to the output power of AND gate U4, U4/Z), can be partially considered in estimating the output power of circuit 400A (e.g., at OR gate U5), as shown in FIG. 4A.

To implement the power and timing regions, some implementations give a weight to the output swings based on the corresponding regions as described below. In some implementations, the multiple gates of the circuit are in a cascading configuration, such as the configuration in circuit 400A, in which the output of at least one first gate can be input into at least one second gate (and so on and so forth). For such cascaded circuits, power analysis can be performed according to method 500 of FIG. 5, described next.

FIG. 5 is a flow chart corresponding to a method 500 performed by one or more specialized components, such as one or more of specialized components 340 of FIG. 3, to provide power analysis of a circuit, according to some implementations. More specifically, method 500 illustrates exemplary steps can be performed by the specialized components, as detailed below.

At step 510, the specialized components simulate an input event on a gate of a circuit. The input event on the gate can be simulated by performing switching activities on the gate in order to estimate output power for the gate. The switching activities can be performed during a time interval, which can be a clock cycle, multiple clock cycles, or a fraction of a clock cycle. The specialized components can then estimate the output power of the gate based on the pulse seen at the input of the gate during the time interval of the switching activities (e.g., the positive or negative pulse width), as described below with reference to steps 520-570.

At decision step 520, the specialized components determine whether the pulse width at the output of the gate during the time interval is below a first threshold, which can correspond to a glitch. Such a time interval during which the pulse width is below the first threshold is referred to herein as an “output power reject region” in which the input event does not propagate to the output of the gate. If the pulse width is below the first threshold (decision step 520: yes), method 500 proceeds to step 530.

At step 530, the specialized components estimate the output power such that only a fraction of the input event can be considered and contributes to the estimated output power for the gate.

If the pulse width is not below the first threshold (decision step 520: no), the specialized components proceed to decision step 540 and determine whether the pulse width is between the first threshold (e.g., 0.03) and a second threshold (e.g., 0.056) (e.g., at or above the first threshold and below the second threshold). Such a time interval during which the pulse width is between the first threshold and the second threshold is referred to herein as an “output timing reject region” in which the input event does not propagate to the output of the gate. If the pulse width satisfies this condition and is between the first threshold and the second threshold (decision step 540: yes), method 500 proceeds to step 550. At step 550, the specialized components estimate the output power such that the input event contributes partially to the estimated output power as a fraction of the affected output partial swings.

If the pulse width is neither below the first threshold nor between the first threshold and the second threshold (i.e., at or above the second threshold, e.g., 0.056) (decision step 540: no), method 500 proceeds to step 560. Such a time interval during which the pulse width is at or above the second threshold is referred to herein as an “output timing inertial region” in which the output event propagates to the output of the gate. At step 560, the specialized components estimate the output power such that the input event contributes fully to the estimated output power.

In some implementations, the specialized components can estimate the output power for the gate by implementing a live gate model, as described further herein with respect to FIG. 6. The live gate model can use gate datasheet information stored by the gate that estimates the output power of the gate based on an input event. The gate model data structure can include information available in the gate datasheets and can take into account, for example, aging of the gate. The gate datasheet information can include one or more parameters corresponding to the gate, such as delay, transition time, output capacitance, etc. In some implementations, the live gate model can calculate the one or more parameters dynamically while the input event is being simulated.

Steps 530, 550, and 560, each proceed to step 570. At step 570, method 500 includes the estimated output power of the gate in the power analysis of the circuit. In some implementations, the specialized components can estimate the output power for the gate as the switching activities occur. In some implementations, the power analysis of the circuit can include estimated output powers for multiple gates within the circuit. For example, method 500 can be performed repeatedly, concurrently, or consecutively, for each of multiple gates in the circuit over the same time interval. Thus, the total estimated output power for the circuit, including the multiple gates, can be estimated at step 570.

The first step for both delay and power calculation can be to estimate the input transition of all gates in the circuit, as further illustrated in circuit 400A of FIG. 4A, for example. To estimate the delay on the path from U3/B to U3/Z, considering the state of U3/A, some implementations can look-up a corresponding table in the gate with the falling transition time of U3/B and the load capacitance at U3/Z. Therefore, the rising transition time of U3/B can be estimated based on the previous gate (U1) before U3 delay is estimated. According to some implementations described herein, because the simulation and estimation environments are integrated, the timing characterization, including the delay and transition propagation, can be performed dynamically and simultaneously with the circuit logic simulations.

FIG. 6 is a flow chart corresponding to a method 600 performed by one or more specialized components, such as one or more of specialized components 340 of FIG. 3, to provide power analysis of a circuit, according to some implementations. More specifically, method 600 illustrates exemplary steps that can be performed by the specialized components, as detailed below.

At step 610, the specialized components simulate an input event on a gate of a circuit. The input event on the gate can be simulated by performing switching activities on the gate in order to estimate output power for the gate. The switching activities can be performed during a time interval, which can be a clock cycle, multiple clock cycles, or a fraction of a clock cycle. The specialized components can then estimate the output power of the gate based on a live gate model modeling the specific behavior of the gate, as described further herein with respect to steps 620-640.

At step 620, the specialized components estimate, by the live gate model, one or more parameters of the gate. The live gate model can be implemented via C++ or SystemC classes. The one or more parameters can include, for example, delay, transition time, output capacitance, etc., based on gate datasheet information stored by the gate. The gate datasheet information can be specific to a data structure of the gate. For example, the live gate model can calculate the one or more parameters based on gate-specific information, such as aging of the gate. In some implementations, the live gate model can calculate the one or more parameters of the gate dynamically while the switching events are being simulated on the gate.

At step 630, the specialized components estimate output power of the gate based on the simulated input event and the one or more estimated parameters by applying the live gate model. At step 640, method 600 includes the estimated output power of the gate in the power analysis of the circuit. In some implementations, the specialized components can estimate the output power for the gate as the switching activities occur. In some implementations, the power analysis of the circuit can include estimated output powers for multiple gates within the circuit. For example, method 600 can be performed repeatedly, concurrently, or consecutively, for each of multiple gates in the circuit over the same time interval. Thus, the total estimated output power for the circuit, including the multiple gates, can be estimated at step 640

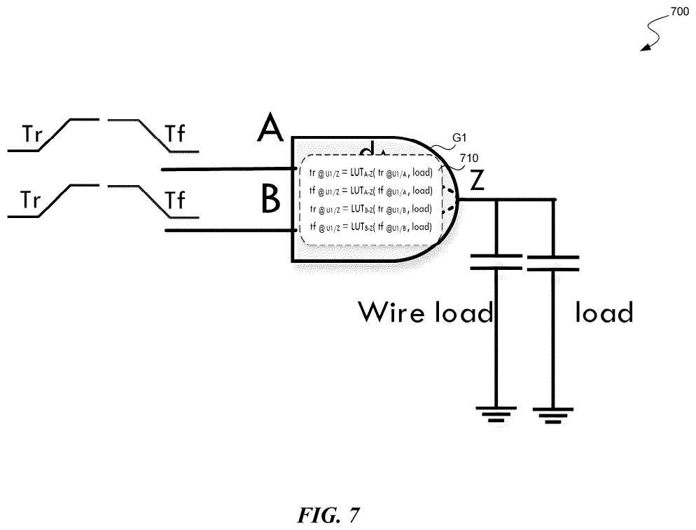

In various implementations, timing models of a gate can include the delay and the transition time of the output pin of the gate. These models are non-linear models represented in separate look-up tables as functions of two variables, transition time of inputs and the load capacitance. FIG. 7 illustrates a circuit 700 including an AND gate G1, having gate datasheet information 710 illustrating transition time arcs, for which power analysis can be performed according to method 600 of FIG. 6. Gate G1 has two inputs, A and B, and an output, Z, having a wire load and load (e.g., a net gate input capacitance) thereon, together making up the output net capacitance of gate G1. The load capacitance can be estimated using a static capacitance estimation mechanism implementing a backward fan-in reporting process. The wire capacitance can be estimated and added to the total net capacitance by using wire load models and wire lengths. As shown in gate datasheet information 710, the fall and rise transition times on the output pin Z are characterized for both inputs, A and B, resulting in four lookup tables.

Each of inputs A and B can receive a changed input signal having respective rise times (Tr) and fall times (Tf). Gate G1, via a live gate model, can calculate the rise and fall times at the output, Z, based on the rise and fall times at the inputs, A and B, as well as the load at the output, Z. In this example, the live gate model can look up the rise and fall times at the output, Z, based on entries on a lookup table. The live gate model can further calculate delay and power for gate G1, as described further with respect to FIG. 6. By transferring gate datasheet information 710 inside the gate, some implementations described herein enable simultaneous simulation and estimation, and provide for dynamic analysis of time and power.

In some gates, like XOR (not shown), the timing arcs are dependent on the state of the other input pins. This means that the timing on the output pin can be different for each combination of states of inputs. These combinations can be specified in the gate as a number of conditions. The delay caused by the first input may, for example, be characterized by two conditions on the second input. Hence, the delay tables can extend for each of these conditions, for both inputs and for both fall and rise transitions, resulting in eight timing tables.

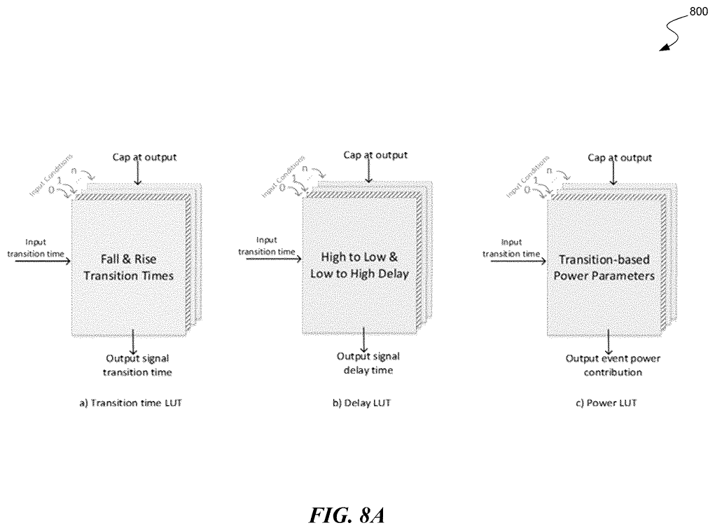

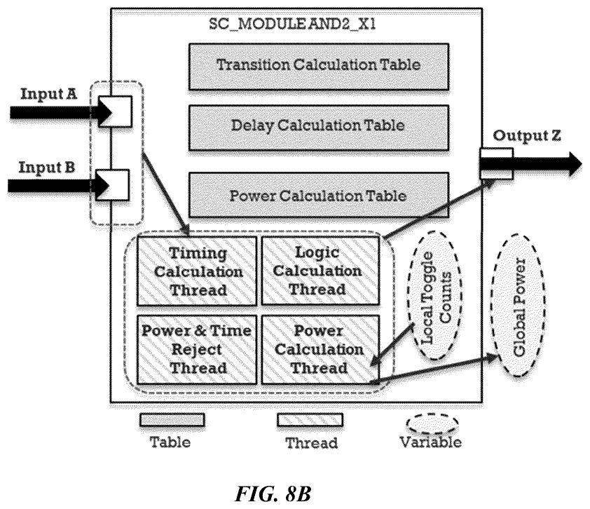

FIG. 8A illustrates a cell library 800 of cell structures of a given technology file modeled as SystemC modules with input and output ports, according to some implementations. An environment that consists of interconnected SystemC gate modules can perform simulation of timing and power in a distributed function depending on gate functionality and parameters. The required data structure for simulation can be distributed among individual gate models, and collection of information for an entire circuit can happen by individual gate modules.

As discussed, coupled timing and power simulation can be distributed among SystemC gate modules. In some implementations, these gate modules include three look-up tables based on which all power and timing calculations take place. FIG. 8B illustrates a set of lookup tables 850 according to some implementations. Lookup tables 850 include a Transition Calculation Table, a Delay Calculation Table, and a Power Calculation Table. These tables represent transition times for the output, output delay values, and transition-based power values. These tables can be indexed by gate output capacitance (columns) and input transition times (rows). Further indexing can be done by input conditions (table depths) for state-dependent gates like XOR and AOI.

Having available its output capacitance, when an event occurs on an input of a gate, the gate model can look up its fall or rise output transition time, its output delay, and a value representing the energy consumed within the gate by the input event. The former two timing parameters are propagated to the gate output, and the latter (energy) can be kept within the gate to be collected when power calculation interval calls for it.

Of the three indexes used by the look-up tables, the output capacitance can be static and calculated based on gate's fanout and output wire length, and can be kept in the gate model. The other two indexes for transition time and input conditions can be dynamic and can have new values for every input event. The input transition time of a changing input can come to a gate model along with its new logic value. The other input conditions can be read by the gate model when an input event occurs. The data structure of a gate can contain a toggle count that participates in gate's energy calculation along with information from the Transition time LUT, Delay LUT, and Power LUT of FIG. 8A.

Given the data available to a gate module, and the local data structure of a gate, the distributed combined power and timing computations can occur within gates in some implementations. The procedure shown below illustrates this computation according to some implementations. As shown, there are two parts to this procedure: a static part A and a dynamic part B. The first part, part A, calculates gate output capacitances that are static values within gates. This part can be initiated by input events at time 0. Gates at the fanout of a gate that drives them will report their capacitances to the driving gate. At the same time, net capacitances estimated based on the technology file information are also reported and summed by the driving gate.

Procedure 1: Event-driven Power Calculation

A for i ← 1 to number of nets of netlist do

| | | |
|---|---|---|
| 2 | \| | Backward fan-in reporting at time 0 |
| 3 | \| | Fanout and load capacitance estimation for each net (1) at time 0 |
| 4 | \| | Wire capacitance estimation at time 0 |
| 5 | \| | end |

B for every event do

| 1 | \| | Calculate transition and delay by LUT | |
|---|---|---|---|
| | \| | Estimate the input toggling ITgl(i) for each input of gate | |
| 2 | \| | Evaluate output logic of the output node | |
| 3 | \| | Evaluate the power and timing regions | |
| 4 | \| | Schedule the output logic based on the power and timing regions | |
| 5 | \| | If output toggles then | |
| 6 | \| | \| | Estimate the toggling based on power region and α, |
| | \| | \| | OTgl(i) + α |

| | | |
|---|---|---|
| 7 | \| | End |
| 8 | \| | Estimate the switching power and internal power |
| | \| \| \| | $\frac{\sum IT gl ( i ) * ( OT gl ( i ) + α )}{\sum IT gl ( i )} + 0.5 * {C}_{net} * Vdd 2$ |
| 9 | \| | Report total power within a sprocket time |
| 10 | \| | end |

The second part, part B, of this procedure is the dynamic part that can be triggered by events on a gate's inputs. The steps taken when an event occurs on a gate input are shown in this procedure.

After delay and transition calculation, comes input toggling calculations, i.e., IT gl(i), which can be then followed by the part for placing output values depending on the timing regions.

As shown in Procedure 1.B (Line 5), after scheduling an output value, if that causes a value change, then the output toggle count will be done. The effect of partial glitches on the power can be considered here by the parameter a in the output toggle count. Line 8 of Procedure 1.B is where the time interval for energy calculation has arrived. In this case, the input and output toggle counts are used in the equation shown for power calculation.

In some implementations, a gate SystemC module contains concurrent threads for delay, power, output value, and transition time calculations. These concurrent processes are triggered by events on the input ports or internal gate events. Each gate model collects and retains the number and weights of events that contribute to the power consumption of the gate. A sprocket signal causes all gates to report their power consumption to a global power data structure. When this happens, a gate calculates its consumed power and reports it to the global power data table.

Table A below lists several benchmark circuits in the first column, the corresponding number of gates for each benchmark in the second column, speed-up in the third column and the accuracy in the last column. This table illustrates the improvement achieved by some implementations. In particular, Table A reports the power estimation speed-up and accuracy of some implementations (specifically, using SystemC gate modules and implementing the gate procedure in C++, in an environment such as that of FIG. 3) in comparison to conventional power estimation tools (e.g., PrimeTime PX power analysis tool). The sizes of benchmark circuits in terms of number of gates and also the activity factors of testbenches are listed in Table A. To evaluate the accuracy, Relative Squared Error metric can be applied to have a relative comparison between the two estimation methods.

TABLE A
Power estimation tool performance

| Power estimation tool | | | Accuracy |
|---|---|---|---|
| performance Benchmark | # Gates | Speed-up | (% Relative Error) |
| C17 | 6 | 119X | 0.93 |
| C499 | 196 | 30X | 0.98 |
| C432 | 221 | 29X | 1.06 |
| C2670 | 461 | 30X | 0.74 |
| C2688 | 1408 | 24X | 0.83 |
| Kog16 | 106 | 112X | 1.25 |
| Kog32 | 244 | 41X | 2.14 |
| Average | | 55X | 1.13 |

As indicated by Table A, the improvement in accuracy results in a mean error of 1.13% for all benchmark circuits that shows the accuracy in both timing simulation and power estimations. The maximum error is 2.14% related to the Kog32 circuit. To evaluate the coupled power and timing simulation runtime performance, the speed-up versus the conventional power estimator is estimated and listed in Table A.

As mentioned, the entire process of power and timing simulation can be distributed among individual gate models in SystemC. As such, a gate instance can be an instance of an SC_MODULE for that gate that has concurrent threads responsible for performing the above-mentioned procedure.

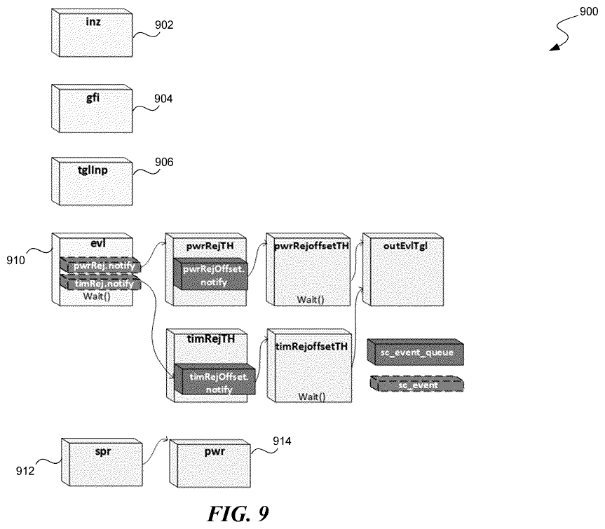

FIG. 9 shows an overall flow 900 of a system architecture, according to some implementations. As mentioned, gate instances can include several concurrent threads that are processing the power estimation concurrently. These threads are referred to as SC_THREADs and are shown as boxes in FIG. 9. Each thread's name is written at the center upper part of the corresponding box. These threads are described as follows.

Thread 902 (thread inz) can be responsible for initializing all the corresponding parameters inside the power estimation module and will be executed once at the beginning of a simulation run (time zero).

Thread 904 (thread gfi) can be responsible for the gate fan-in reporting and net capacitance estimations. Each gate calculates its output capacitance based on the number of its fan-outs. Number of each gate's fanout is reported in a backward mechanism at the time zero of simulation. This can be a one-time static process and performs the steps shown in Procedure 1.A (Lines 1 to 4).

Thread 906 (thread tglInp) calculates and stores the number of times gate inputs toggle. The number of times gate inputs toggle are stored in specific gate data structures for power estimation based on equation in Procedure 1.B (Line 8). This thread calculates the ITgl in Procedure 1.B (Line 1),

Thread 910 (thread evl) can be the main thread for the gate logic simulation and can be triggered on every new data on the gate inputs. Thread 910 performs the logic simulation and lookups the required parameters like transition and delay values, such as described earlier with reference to step 620 of method 600 of FIG. 6. There can be two thresholds for the power region, power reject and timing reject evaluation. Thread 910 notifies two flows (threads) (thread PwrRjTH) and (thread timRjTH) for the required evaluations for the power reject and timing reject regions, respectively. By executing these two concurrent threads, blocks 520 or 540 of FIG. 5, described above, can be performed. These decisions can be implemented implicitly by the threads as passing each region's time threshold inside each thread, causing the output toggling values to be stored or ignored. Threads (PwrRjOffsetTH) and (timRejOffsetTH) can come after the first region threads. The two flows of the threads are generated based on the concept of SystemC event notify. SC_event_queues are used to store the output values when its timing passes the region's threshold.

Thread (outEvlTgl) can estimate the output toggling value. Blocks 530, 550 or 560 of FIG. 5, described above, can be performed by passing the two region's threshold times and reaching the last region time frame. During the (PwrRjTH) and (timRjTH) threads, the output logic value can be stored in a queue and based on the value, the output switching can be estimated. This thread made calculate the OTgl in Procedure 1.B above (Line 5 to 7) based on the region and add a ratio, a portion or a full count (parameter a in Procedure 1.B (Line 6)) to the toggling of the output.

Thread 912 (thread spr) and thread 914 (thread pwr) are responsible for performing block 630 of process 600. Thread 912 can generate a time sprocket with the help of which all gates report their power values. On each new sprocket, thread 912 can be triggered and thread 914 can look up inside the Power LUT of FIG. 8A, and calculate the power based on Line 8 of Procedure 1.B.

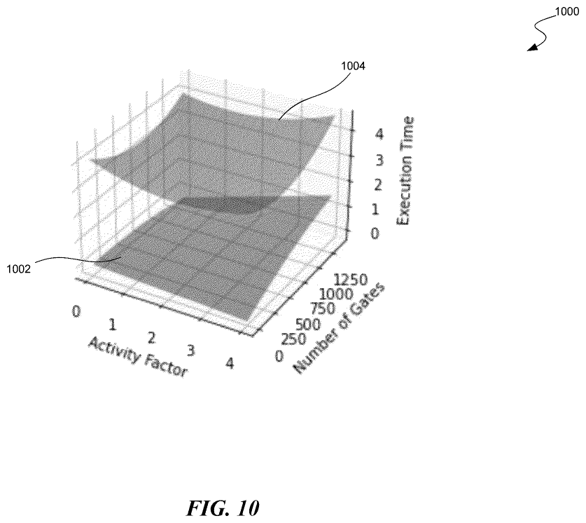

FIG. 10 is a graph 1000 illustrating some aspects of the improvements achieved by some implementations. More specifically, graph 1000 depicts the execution time of different benchmark circuits in relation to the number of gates and the testbench activity factor. Plate 1002 shows the estimation time according to the implementations described herein, while plate 1004 shows conventional estimation time. FIG. 10 shows that the power computation time in some implementations described herein grows slowly with the number of gates. This is unlike the conventional tool that has a faster linear growth. Some implementations described herein outperforms the conventional tool by a factor of nearly 25 for circuits with 1,000 gates.

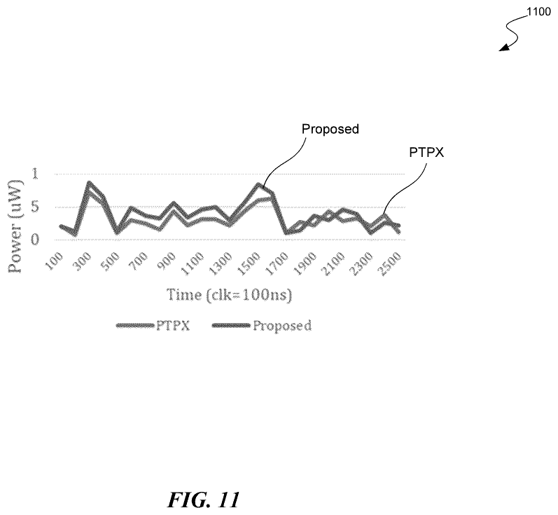

Some implementations described herein can be applied for the purpose of side-channel leakage power analysis of an AES (Advanced Encryption Standard) circuit. This analysis is used for security evaluation of cryptographic applications. FIG. 11 is a graph 1100 illustrating another aspect of the improvements achieved by some implementations. More specifically, graph 1100 shows the power traces of an S-box submodule of an AES circuit simulated and estimated by some implementations described herein, versus PrimeTime PX (commercial tool) estimations. As shown, the implementations described herein exhibit improved accuracy relative to conventional tools.

Those skilled in the art will appreciate that the components illustrated in FIGS. 1-3 described above, and in each of the flow diagrams discussed herein, can be altered in a variety of ways. For example, the order of the logic can be rearranged, substeps can be performed in parallel, illustrated logic can be omitted, other logic can be included, etc. In some implementations, one or more of the components described above can execute one or more of the processes described below.

Modifications and variations are possible in light of the above teachings or can be acquired from practicing the implementations. For example, the described steps need not be performed in the same sequence discussed or with the same degree of separation. Likewise various steps can be omitted, repeated, combined, or performed in parallel, as necessary, to achieve the same or similar objectives. Similarly, the systems described need not necessarily include all parts described in the implementations, and can also include other parts not described in the implementations. Accordingly, the implementations are not limited to the above-described details, but instead are defined by the appended claims in light of their full scope of equivalents. Further, the present disclosure is directed toward all novel and non-obvious features and aspects of the various disclosed implementations, alone and in various combinations and sub-combinations with one another.

Those having ordinary skill will appreciate that various changes can be made to the above implementations without departing from the scope of the disclosure.

Although some aspects have been described in the context of a system or an apparatus, in some implementations these aspects can also represent a description of the corresponding method, where a block or device corresponds to a method step or a feature of a method step. Analogously, aspects described in the context of a method step can also represent in some implementations a description of a corresponding block or item or feature of a corresponding apparatus.

The foregoing description of the implementations has been presented for purposes of illustration only. It is not exhaustive and does not limit the implementations to the precise form disclosed. While several exemplary implementations and features are described, modifications, adaptations, and other implementations can be possible, without departing from the spirit and scope of the implementations. Accordingly, unless explicitly stated otherwise, the descriptions relate to one or more implementations and should not be construed to limit the implementations as a whole. This is true regardless of whether or not the disclosure states that a feature is related to “a,” “the,” “one,” “one or more,” “some,” or “various” implementations. As used herein, the singular forms “a,” “an,” and “the” can include the plural forms unless the context clearly dictates otherwise. Further, the term “coupled” does not exclude the presence of intermediate elements between the coupled items. Also, stating that a feature can exist indicates that the feature exists in one or more implementations but not necessarily in all implementations.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set can include one or more members, and a subset of a set can include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some implementation, a first variable can be an increasing or a decreasing function of a second variable if, respectively, the first variable is directly or inversely proportional to the second variable.

The disclosed compositions, systems, methods, and apparatus are not limited to any specific aspect or feature or combinations thereof, nor do the disclosed compositions, systems, methods, and apparatus require that any one or more specific advantages be present or problems be solved. Any theories of operation are to facilitate explanation, but the disclosed compositions, systems, methods, and apparatus are not limited to such theories of operation.

Modifications and variations are possible in light of the above teachings or can be acquired from practicing the implementations. For example, the described steps need not be performed in the same sequence discussed or with the same degree of separation. Likewise various steps can be omitted, repeated, combined, or performed in parallel, as necessary, to achieve the same or similar objectives. Similarly, the systems described need not necessarily include all parts described in the implementations, and can also include other parts not described in the implementations. Accordingly, the implementations are not limited to the above-described details, but instead are defined by the appended claims in light of their full scope of equivalents. Moreover, subsets of elements or parts of different implementations can be combined, if feasible, to create new implementations not disclosed. Such implementations can also include disclosed methods for which the elements or parts include method steps.

Further, the present disclosure is directed toward all novel and non-obvious features and aspects of the various disclosed implementations, alone and in various combinations and sub-combinations with one another.

While the present disclosure has been particularly described in conjunction with specific implementations, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for providing power analysis of a circuit, the method comprising:
estimating output power during a time interval for a gate of the circuit based on an input event,
wherein:
estimating the output power includes considering, for the gate, an output timing reject region of the input event,
the output timing reject region has a pulse width between a first threshold and a second threshold,
the first threshold and the second threshold are selected such that the input event does not propagate to an output of the gate, and
the input event contributes to the estimated output power for the gate; and
including the estimated output power of the gate in the power analysis of the circuit.

2. The method of claim 1, wherein estimating the output power further includes implementing a live gate model that uses gate datasheet information stored by the gate.

3. The method of claim 2, wherein the gate datasheet information includes a parameter corresponding to the gate, the parameter comprising at least one of delay, transition time, or output capacitance.

4. The method of claim 3, wherein the parameter is calculated by the live gate model for the gate dynamically while simulating the input event.

5. The method of claim 2, wherein the gate datasheet information is specific to a data structure of the gate.

6. The method of claim 2, wherein the live gate model is a SystemC model.

7. The method of claim 2, wherein a sprocket signal causes the live gate model to estimate its output power corresponding to the gate.

8. The method of claim 1, wherein:
the gate is a first gate,
the circuit includes a plurality of gates including the first gate and a second gate,
the input event is a first input event included in a plurality of input events respectively occurring on the plurality of gates for the time interval, and
the method further comprises:
estimating output power during the time interval for the second gate based on a second input event of the plurality of input events, wherein:
estimating the output power includes considering, for the second gate, an output power reject region of the second input event,
the output power reject region has a pulse width below the first threshold,
the first threshold is defined such that the second input event does not propagate to an output of the second gate, and
the second input event either does not contribute to the output power or a ratio of the second input event contributes to the output power; and
estimating a total power for the time interval by including the estimated output power of the second gate in the power analysis of the circuit.

9. The method of claim 8, wherein the first gate is cascaded with the second gate.

10. The method of claim 8, wherein the second input event is a glitch defined by the pulse width of the second input event being below the first threshold.

11. The method of claim 8, wherein;
the plurality of gates includes a third gate, and
the method further comprises:
estimating output power during the time interval for the third gate based on a third input event of the plurality of input events, wherein:
estimating the output power includes considering, for the third gate, an output timing inertial region of the third input event,
the output timing inertial region has a pulse width above the second threshold,
the second threshold is defined such that the third input event propagates to an output of the third gate, and
the third input event fully contributes to the output power; and
estimating a total power for the time interval by including the estimated output power of the third gate in the power analysis of the circuit.

12. The method of claim 1, wherein:
the gate is a first gate,
the circuit includes a plurality of gates including the first gate and a second gate,
the input event is a first input event included in a plurality of input events respectively occurring on the plurality of gates for the time interval, and
the method further comprises:
estimating output power during the time interval for the second gate based on a second input event of the plurality of input events, wherein:
estimating the output power includes considering, for the second gate, an output timing inertial region in which the pulse width of the second input event is above the second threshold,
the second threshold is defined such that the second input event propagates to an output of the second gate, and
the second input event fully contributes to the output power; and
estimating a total power for the time interval by including the estimated output power of the second gate in the power analysis of the circuit.

13. The method of claim 1, wherein:
the input event is a simulated switching activity on the gate, and
the output power is estimated as the switching activity occurs.

14. The method of claim 1, wherein:
the circuit includes a plurality of gates including the gate,
the input event is included in a plurality of input events occurring on the plurality of gates, and
the output power is estimated for the plurality of gates based on the plurality of input events.

15. The method of claim 14, wherein at least one first gate, of the plurality of gates,
is cascaded with at least one second gate of the plurality of gates.

16. The method of claim 1, wherein the power analysis includes integrated timing characterization and logic simulation.

17. The method of claim 1, wherein the time interval is a clock cycle.

18. The method of claim 1, wherein the time interval is a fraction of a clock cycle.

19. A method for providing power analysis of a circuit, the method comprising:
estimating output power during a time interval for a gate of the circuit based on an input event,
wherein:
estimating the output power includes implementing a live gate model using gate datasheet information stored by the gate,
the gate datasheet information is specific to a data structure of the gate,
the gate datasheet information includes at least one parameter, and
the at least one parameter comprises at least one of delay, transition time, or output capacitance; and
including the estimated output power of the gate in the power analysis of the circuit.

20. The method of claim 19, wherein the live gate model calculates the at least one parameter based on aging of the gate.
